(19) United States
(12) Patent Application Publication
(10) Pub. No.: US 2016/0233617 A1
(43) Pub. Date: Aug. 11, 2016

(54) SERIAL BUS CONNECTOR

(71) Applicant: Chant Sincere Co., Ltd., New Taipei City (TW)

(72) Inventors: Ming Hui YEN, New Taipei City (TW); Huagu ZI, New Taipei City (TW); Chun-Hsiang HSU, New Taipei City (TW)

(21) Appl. No.: 14/956,696

(22) Filed: Dec. 2, 2015

(30) Foreign Application Priority Data
Feb. 6, 2015 (TW) 104201948

(51) Int. Cl. H01R 13/6581; H01R 24/60

(52) U.S. Cl. CPC H01R 13/6581; H01R 24/60; H01R 2107/00

(57) ABSTRACT

A serial bus connector is provided, including a plurality of rows of terminals, an insulated body, a base assembly, and a plate assembly. The insulated body is used for accommodating a portion of the respective terminal and has a plurality of openings formed on an end thereof. The base assembly is used for accommodating another portion of the respective terminal and assembled with the insulated body. The plate assembly is assembled with the base assembly and comprises at least one protrusion for engaging in the corresponding opening of the insulated body to retain the plate assembly with the insulated body, thereby increasing a structural firmness in the assembly of the plate assembly and the insulated body.

### CROSS-REFERENCE TO RELATED APPLICATIONS

This application claims the benefit of the filing date under 35 U.S.C. §119(a)-(d) of Taiwan Patent Application No. 104201948, filed Feb. 6, 2015.

### BACKGROUND OF THE INVENTION

1. Field of the Invention

The present invention relates to a serial bus connector, and more particularly to a serial bus connector which has a robust structure.

2. Description of the Related Art

Nowadays, electronic devices can be connected with a computer for transmitting data via a variety of connectors, and universal serial bus (USB) connectors, which have high transmission speed, in particular have been widely applied. With the development of the technique of the serial bus connector, a new universal serial bus connector, such as a Type-C USB connector which is based on the specifications of USB 3.1, has been developed, wherein an interface size of the new universal serial bus connector is smaller than a standard specification of a Micro-USB, and the transmission speed is above 10 Gbit/s. On the other hand, in order to meet the user's requirements, the new universal serial bus connector can be designed to allow for electrically connecting with another complementary connector via up or down orientations. To be specific, in a mating interface of the connector, terminals of an upper row have configurations similar to configurations of terminals of lower row, thereby achieving the above mentioned effect.

Please refer to FIG. 1 and FIG. 2. FIG. 1 shows an exploded diagram of a serial bus connector 10 according to the prior art, and FIG. 2 shows a partial assembly diagram of the serial bus connector 10 according to the prior art. An interface size of the serial bus connector 10 may be smaller than the standard specification of Micro-USB, and/or it allows for electrically connecting with a complementary connector via up or down orientations. The serial bus connector 10 comprises a first terminal seat 20, a second terminal seat 25, an insulated body 30, a first row of terminals 40, a second row of terminals 45, a first conductive cover 50, a second conductive cover 55, a plate assembly 60, and an outer shielding 70, wherein the first terminal seat 20 and the second terminal seat 25 are respectively secured to the first row and second row of terminals 40, 45 by insert molding.

As shown in FIG. 1 and FIG. 2, the plate assembly 60 comprises a plate body 61 and a pair of elastic arms 62 which are opposite each other, and a pair of hook sections 63 are respectively formed on ends of the pair of elastic arms 62. Moreover, a pair of slots 31 are formed on left and right side walls of the insulated body 30, and the insulated body 30 comprises a pair of through holes (not shown in the Figs.) extending from the ends of the slots 31 to an inner of the insulated body 30. When assembled, the first terminal seat 20, the plate assembly 60, and the second terminal seat 25 are sequentially superposed one upon the other, and then they are assembled with the insulated body 30, wherein the pair of the elastic arms 62 of the plate assembly 60 are accommodated in the pair of slots 31 of the insulated body 30, and the pair of hook sections 63 are located on the pair of through holes, so that the pair of hook sections 63 of the pair of the elastic arms 62 pass through the pair of through holes of the pair of slots 31 and then extend to the inner of the insulated body 30. When the serial bus connector 10 electrically connects with a complementary connector (not shown in the drawings), the hook sections 63 engage and electrically contact with the complementary connector.

However, as shown in FIG. 1 and FIG. 2, the plate assembly 60 engages with the insulated body 30 only by the pair of the hook sections 63 on the end of the pair of the elastic arms 62, so that the plate assembly 60 and the insulated body 30 are structurally unsound, and it will cause shaking or disassembling.

Therefore, it is necessary to provide a serial bus connector, the structure design of which is improved so as to increase a structural firmness in the assembly of the plate assembly and the insulated body.

### SUMMARY OF THE INVENTION

In order to solve the above-mentioned technical problems, an objective of the present invention is to provide a serial bus connector which has a small and robust structure thereby providing the connector with a longer service life.

In order to achieve the above objects, the present invention provides a serial bus connector, comprising: an upper row and a lower row of terminals; an insulated body having a plurality of terminal passages formed thereon, each terminal passage used for accommodating a portion of a terminal, and the insulated body comprising a first end and a second end opposite the first end, a plurality of openings formed in the first end, and the second end being configured for connecting with a complementary connector; at least one conductive cover disposed on an outer surface of a side wall of the insulated body; a base assembly used for accommodating another portion of the terminal and used for assembling with the insulated body; a plate assembly located between the upper and lower rows of terminals and assembling with the base assembly, and the plate assembly comprising: at least one elastic arm extending toward the second end of the insulated body, at least one elastic arm extending toward the second end of the insulated body, the at least one elastic arm comprises a hook section on an end thereof and configured for electrically contacting with the complementary connector; at least one ground section extending toward an outside of the insulated body; and at least one protrusion, which is accommodated in a corresponding opening of the insulated body, so that the plate assembly is retained within the insulated body; and an outer shielding sleeved onto the insulated body and the at least one conductive cover.

In one preferred embodiment of the present invention, each the terminal comprises an elastic contact section, a retaining section, and a connecting section, and the insulated body comprises the plurality of terminal passages on two opposite upper and lower side walls thereof, for accommodating the elastic contact sections of the upper and lower of rows of terminals.

In one preferred embodiment of the present invention, the base assembly further comprises a first terminal seat engaging with the upper row of terminals and a second terminal seat engaging with the lower row of terminals, the first and second terminal seats are superposed one upon the other, and the plate assembly is located between the first terminal seat and the second terminal seat.

In one preferred embodiment of the present invention, each terminal seat comprises a plurality of first engaging units, and the insulated body comprises a plurality of upper and lower second engaging units on the first end thereof. The insulated body is assembled with the base assembly by engaging the first engaging unit of each the terminal seat with the corresponding second engaging unit of the insulated body.

In one preferred embodiment of the present invention, each the engaging unit comprises a pair of structurally complementary protrusion and recess.

In one preferred embodiment of the present invention, the first terminal seat comprises at least one blind hole, the second terminal seat comprises at least one post, and the plate assembly comprises at least one locating hole. The at least one post passes through the locating hole and is disposed in the at least one blind hole, so that the plate assembly, the first terminal seat, and the second terminal seat are assembled together.

In one preferred embodiment of the present invention, the at least one elastic arm comprises two elastic arms, insulated body comprises slots respectively formed on two opposite left and right side walls thereof for accommodating the two elastic arms of the plate assembly.

In one preferred embodiment of the present invention, the at least one conductive cover comprises a first conductive cover and a second conductive cover, which respectively cover the plurality of the terminal passages on two opposite upper and lower side walls of the insulated body.

In one preferred embodiment of the present invention, each the conductive cover comprises at least one first elastic tab configured for electrically contacting with the complementary connector.

In one preferred embodiment of the present invention, the insulated body comprises at least one through hole on the two opposite upper and lower side walls thereof, so that the at least one first elastic tab of each the conductive cover passes through the at least one through hole to electrically contact with the complementary connector.

In one preferred embodiment of the present invention, each the conductive cover comprises at least one second elastic tab, which outwardly extends to electrically contact with the outer shielding.

In one preferred embodiment of the present invention, each the conductive cover comprises embedding tabs in two sides thereof, for fixing on the insulated body.

In one preferred embodiment of the present invention, each of the terminals of the upper row has a configuration similar to a configuration of each the terminals of the lower row.

The present invention also provides a universal serial bus connector, comprising: an upper terminal set having an upper row of terminals and a lower terminal set having a lower row of terminals, each of the terminals of the upper row having a configuration similar to a configuration of each of the terminals of the lower row; an insulated body having a plurality of upper terminal passages receiving the terminals of the upper row, a plurality of lower terminal passages receiving the terminals of the lower row, and a first end and a second end opposite the first end, a plurality of openings formed in the first end, and the second end being configured for connecting with a complementary connector; a plate assembly located between the upper and lower rows of terminals and assembling between the upper and lower terminal sets, and the plate assembly comprising: at least one elastic arm extending toward the second end of the insulated body, the at least one elastic arm comprises a hook section on an end thereof extending through the insulated body into an inside thereof and configured for electrically contacting with the complementary connector; at least one ground section extending toward an outside of the insulated body; and at least one protrusion, which is accommodated in a corresponding opening of the insulated body, so that the plate assembly is securely retained to the insulated body; and an outer shielding sleeved onto the insulated body and the upper and lower terminal sets.

### BRIEF DESCRIPTION OF THE DRAWINGS

FIG. 1 shows an exploded diagram of a serial bus connector according to the prior art;

FIG. 2 shows a partial assembly diagram of the serial bus connector of FIG. 1 according to the prior art;

FIG. 3 shows an assembly diagram of a serial bus connector according to the present invention;

FIG. 4 shows a first view of an exploded diagram of the serial bus connector according to the present invention;

FIG. 5 shows a second view of an exploded diagram of the serial bus connector according to the present invention;

FIG. 6 shows a first partial assembly diagram of the serial bus connector according to the present invention;

FIG. 7 shows a second partial assembly diagram of the serial bus connector according to the present invention; and

FIG. 8 shows a third partial assembly diagram of the serial bus connector according to the present invention.

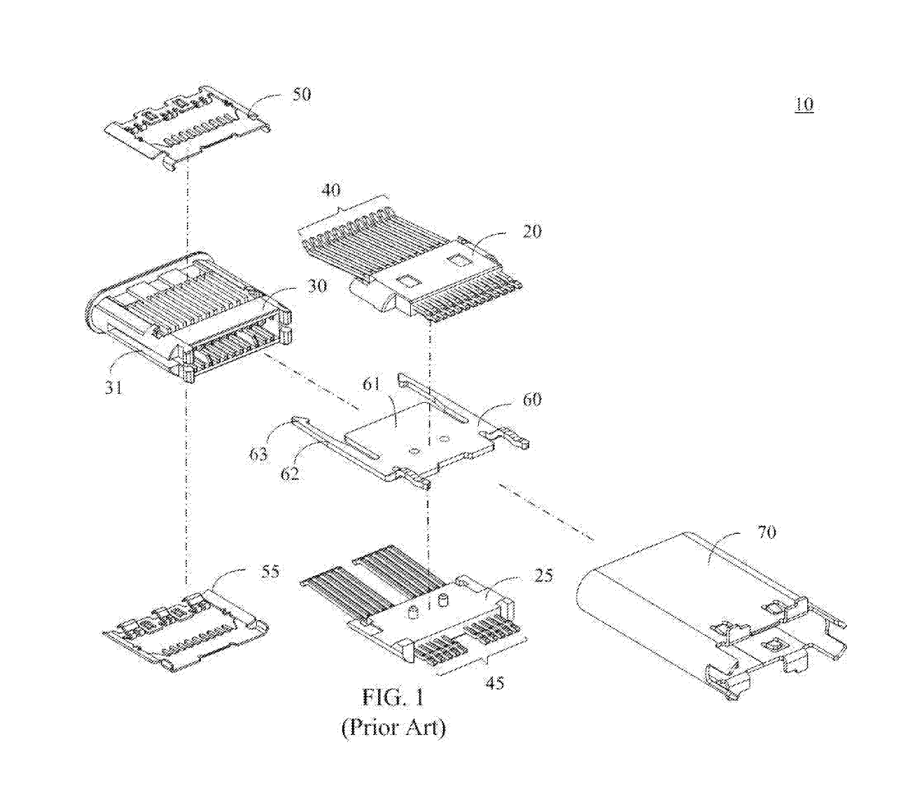

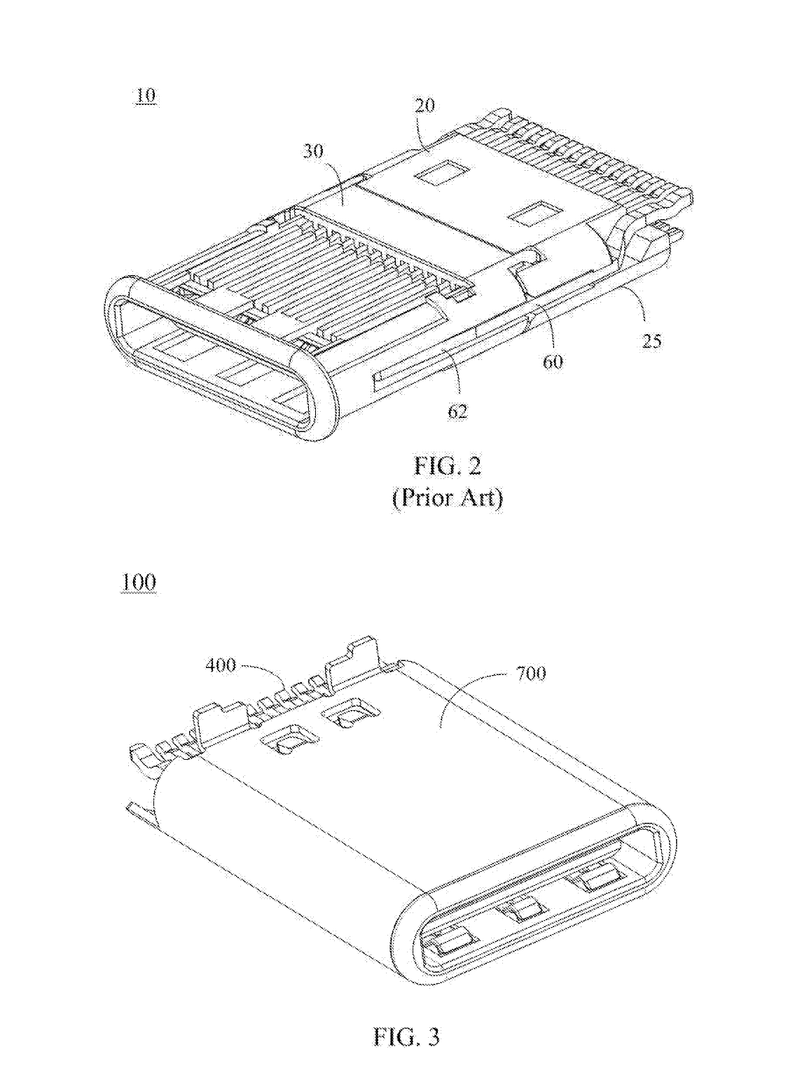

### DETAILED DESCRIPTION OF THE EMBODIMENT(S)

The structure and the technical means adopted by the present invention to achieve the above and other objects can be best understood by referring to the following detailed description of the preferred embodiments and the accompanying drawings. Furthermore, the same reference numerals refer to the same parts or like parts throughout the various figures.

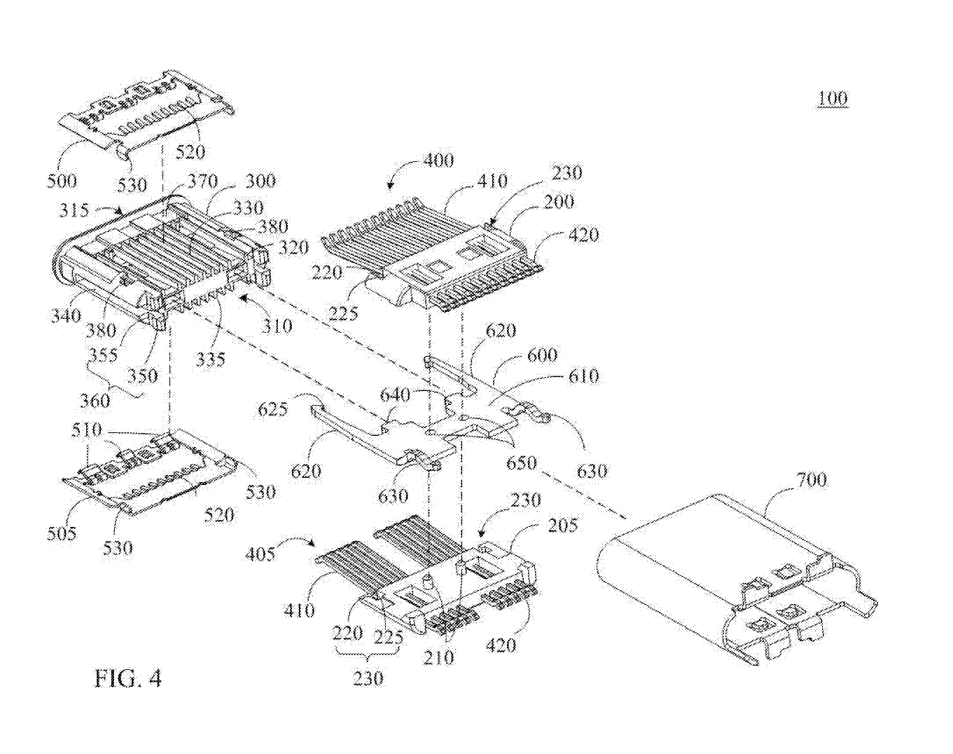

Please refer to FIG. 3 and FIG. 4. FIG. 3 shows an assembly diagram of a serial bus connector 100 according to the present invention, and FIG. 4 shows a first view of an exploded diagram of the serial bus connector 100 according to the present invention. The serial bus connector 100 comprises a base assembly, an insulated body 300, a first row of terminals 400, a second row of terminals 405, a first conductive cover 500, a second conductive cover 505, a plate assembly 600, and an outer shielding 700.

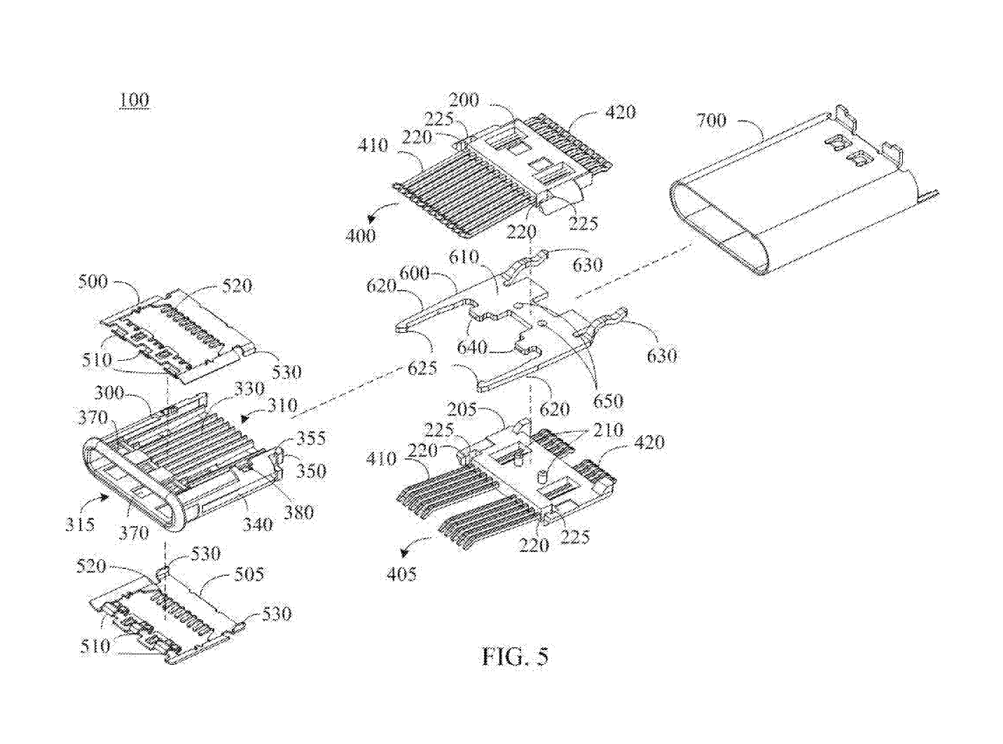

As shown in FIG. 4 and FIG. 5, each terminal of the first row of terminals 400 and the second row of terminals 405 comprises an elastic contact section 410, a retaining section (not shown), and a connecting section 420, wherein the retaining section is located between the elastic contact section 410 and the connecting section 420. The terminals 400 of the first row each have a configuration similar to a configuration of each of the terminals 405 of the second row.

As shown in FIG. 4 and FIG. 5, the base assembly comprises a first terminal seat 200 and a second terminal seat 205, which are superposed one upon the other. The first terminal seat 200 and the second terminal seat 205 respectively cover and securely engage with a portion of the first row of terminals 400 and a portion of the second row of terminals 405. In this embodiment, the retaining sections of the first row of terminals 400 and the second row of terminals 405 are respectively embedded in the first terminal seat 200 and the second terminal seat 205 by an insert molding process. The first terminal seat 200 also comprises a pair of blind holes (not shown) on a surface thereof, and the second terminal seat 205 also comprises a pair of posts 210 on a surface thereof, wherein the pair of posts 210 correspond to the pair of blind holes.

As shown in FIG. 4 and FIG. 5, the insulated body 300 comprises a first end 310 and a second end 315 opposite the first end 310. The first end 310 is used for assembling with the first terminal seat 200, the second terminal seat 205, and the plate assembly 600. The first end 310 also comprises a pair of openings 320, but the number of the openings 320 is not limited thereto. An interface (not labeled in FIG. 5) is formed on the second end 315. A size of the interface may be smaller than the standard specification of Micro-USB, and it can allow for electrically connecting with a complementary connector (not shown) via up or down orientations. The insulated body 300 comprises a first row of terminal passages 330 and a second row of terminal passages 335 on two opposite upper and lower side walls thereof, for accommodating the elastic contact section 410 of the first row of terminals 400 and the elastic contact section 410 of the second row of terminals 405. The first row of terminal passages 330 and the second row of terminal passages 335 extend from the first end 310 toward the second end 315, and are terminated at a distance from the second end 315. p As shown in FIG. 4 and FIG. 5, the plate assembly 600 is located between the superposed first terminal seat 200 and second terminal seat 205 and is grounded for preventing interference caused by high speed signals transmitted by the terminals 400, 405 and/or external signals, such as electrostatic discharge (ESD) or electromagnetic interference (EMI). The plate assembly 600 comprises a plate body 610, a pair of elastic arms 620, a pair of ground sections 630, and a pair of protrusions 640, wherein the plate body 610, the pair of elastic arms 620, the pair of ground sections 630, and the pair of protrusions 640 are a one-piece stamped structure. The pair of elastic arms 620 and the pair of ground sections 630 are located on two opposite sides of the plate body 610, and the elastic arms 620 and the ground sections 630 extend toward two opposite directions. A pair of hook sections 625 are formed on ends of the pair of elastic arms 620. The pair of protrusions 640 extend from the plate body 610 toward the pair of openings 320 of the first end 310 of the insulated body 300, and the number of the protrusion 640 is not limited thereto. The plate body 610 comprises a pair of locating holes 650 which respectively correspond the pair of blind holes (not shown) of the first terminal seat 200 and the pair of posts 210 of the second terminal seat 205.

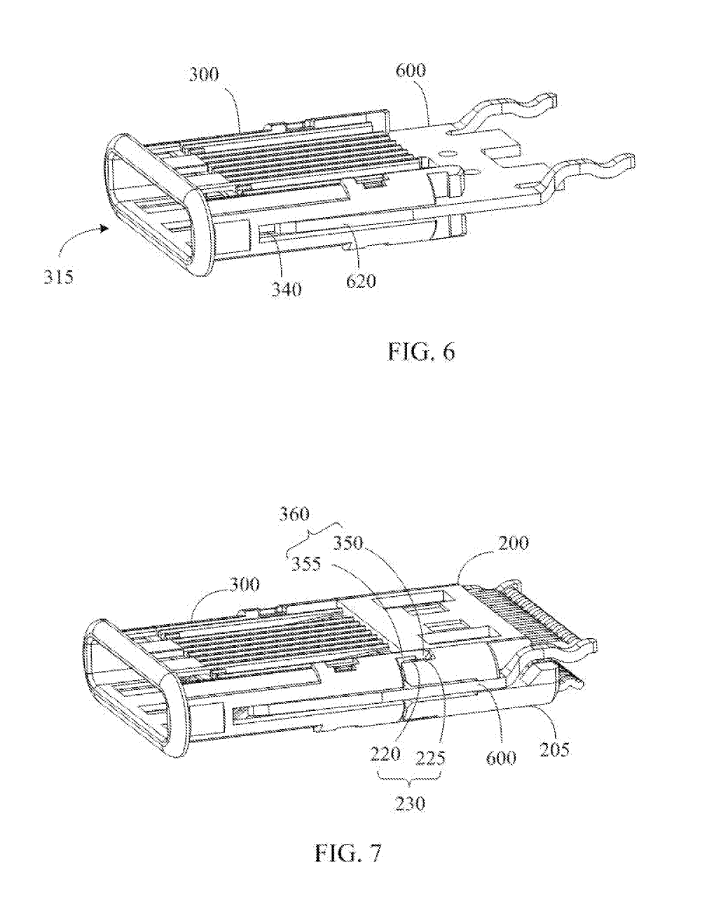

Please refer to FIG. 4 and FIG. 6. FIG. 6 shows a first partial assembly diagram of the serial bus connector 100 according to the present invention. When the plate assembly 600 is assembled to the insulated body 300, the pair of elastic arms 620 extend to the second end 315 along a pair of slots 340 of the insulated body 300, and the pair of ground sections 630 extend to the outside of the first end 310 of the insulated body 300. The pair of slots 340 are formed on left and right sides of the insulated body 300, for accommodating the pair of elastic arms 620 of the plate assembly 600. On the extension direction of the pair of slots 340, a pair of through holes (not shown) are formed on the end of each slot 340, and extend to an inner of the insulated body 300, so that the pair of hook sections 625 of the elastic arms 620 pass through the through holes of the pair of slots 340 and extend to the inner of the insulated body 300. The hook sections 625 engage and electrically contact the complementary connector when the serial bus connector 100 is electrically connected with the complementary connector.

As shown in FIG. 4 and FIG. 6, when the insulated body 300 is assembled with the plate assembly 600, the pair of openings 320 of the insulated body 300 are used for accommodating the pair of protrusions 640 of the plate assembly 600, thereby retaining the plate assembly 600 within the insulated body 300. That is, in the serial bus connector 100 of the present invention, the pair of elastic arms 620 of the plate assembly 600 engage with the pair of through holes on the two left and right side walls of the insulated body 300, and the pair of protrusions 640 of the plate assembly 600 engage and are fixed in the pair of openings 320 on the first end 310 of the insulated body 300, thereby increasing the structural firmness in the assembly of the plate assembly 600 and the insulated body 300.

Please refer to FIG. 4 and FIG. 7. FIG. 7 shows a second partial assembly diagram of the serial bus connector 100 according to the present invention. After the plate assembly 600 is assembled with the insulated body 300, the pair of posts 210 of the second terminal seat 205 pass through the pair of locating holes 650 of the plate assembly 600, and then the pair of posts 210 are disposed in the pair of blind holes of the first terminal seat 200, so that the first terminal seat 200, the second terminal seat 205, and the plate assembly 600 are firmly assembled together. After assembly, the length of the plate body 610 of the plate assembly 600 is shorter than the length of the terminals 400 and terminals 405, and the plate assembly 600 will not contact with the terminals 400 and terminals 405. It should be noted that the sequence for assembling the insulated body 300, the plate assembly 600, the first terminal seat 200, and the second terminal seat 205 is not limited thereto. For example, in the other embodiments, it can be that the plate assembly 600 is firstly assembled with the first terminal seat 200 and the second terminal seat 205, and then they are assembled with the insulated body 300.

As shown in FIG. 4 and FIG. 7, each the terminal seat 200 and terminal seat 205 respectively comprises two first engaging units 230 at opposite lateral sides thereof, and the insulated body 300 comprises two upper and two lower second engaging units 360 on opposite lateral sides of the first end 315 thereof. The first engaging unit 230 comprises a first protrusion 220 and a first recess 225, and the second engaging unit 360 comprises a second protrusion 350 and a second recess 355. The second recess 225 and the first protrusion 220 of the first engaging unit 230 are structurally complementary to the second recess 355 and the second protrusion 350 of the second engaging unit 360, so that the first protrusion 220 and the second protrusion 350 can engage with the corresponding first recess 225 and the corresponding second recess 355. Therefore, in this embodiment, by using the structurally complementary protrusions and recesses, the first engaging unit 230 of each terminal seat 200 and terminal 205 can engage with the corresponding second engaging unit 360 of the insulated body 300, thereby assembling the insulated body 300 with the first terminal seat 200 and the second terminal seat 205.

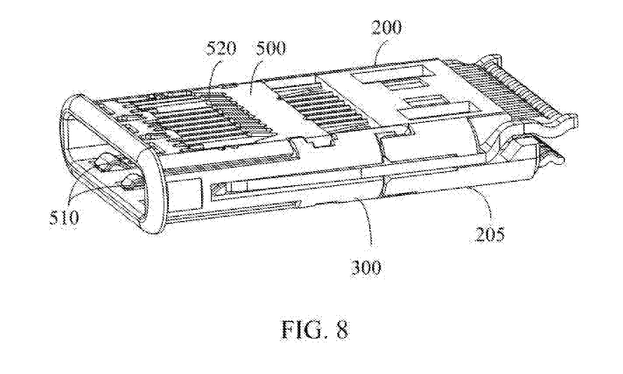

Please refer to FIG. 4 and FIG. 8. FIG. 8 shows a third partial assembly diagram of the serial bus connector 100 according to the present invention. The first conductive cover 500 and the second conductive cover 505 are respectively disposed on the outer surfaces of two opposite upper and lower side walls of the insulated body 300, and cover the first row of terminal passages 330 and the second row of terminal passages 335. The first conductive cover 500 and the second conductive cover 505 are symmetric and have a hollowed-out portion in the center, and they comprise a plurality of first elastic tabs 510 and a plurality of second elastic tabs 520. Each first elastic tab 510 extends toward the direction of the inner of the insulated body 300, so as to electrically contact to a conductive shell of the complementary connector (not shown) which is electrically connected with the serial bus connector 100. The second elastic tab 520 extends in a direction away from the insulated body 300, so as to electrically contact the outer shielding 700. In should be noted that the first elastic tabs 510 and the second elastic tabs 520 of the first conductive cover 500 and the second conductive cover 505 are one-piece stamped structures.

As shown in FIG. 4 and FIG. 8, the insulated body 300 comprises a plurality of through holes 370 on the two opposite upper and lower side walls thereof. The through holes 370 are respectively located on a terminal region of the first row of terminal passages 330 and the second row of terminal passages 335 and adjacent to the second end 315. The first elastic tabs 510 of the first conductive cover 500 and the second conductive cover 505 are bent toward the insulated body 300 and then they extend into the through holes 370 of the insulated body 300, and are configured as a barb-like structure. It should be noted that when viewed from the second end 315 of the insulated body 300, the end of the first elastic tab 510 is lower than an inner surface of the insulated body 300, but the scope of the present invention is not limited thereto.

As shown in FIG. 4 and FIG. 5, the insulated body 300 further comprises a pair of concave portions 380 on two opposite left and right side walls thereof. The left and right sides at the end of each conductive cover 500 and conductive cover 505 are respectively downwardly bent for forming a pair of embedding tabs 530, which are used for engaging to and fixing in the pair of concave portions 380 of the insulated body 300. Preferably, when the first conductive cover 500 and the second conductive cover 505 are respectively disposed on the insulated body 300, the first conductive cover 500 and the second conductive cover 505 are disposed on a plane generally the same as the two opposite upper and lower side walls of the insulated body 300.

As shown in FIG. 3 and FIG. 4, after the first terminal seat 200, the second terminal seat 205, the insulated body 300, the first row of terminals 400, the second row of terminals 405, the first conductive cover 500, the second conductive cover 505, and the plate assembly 600 are assembled together, they will be disposed into the outer shielding 700, so that the outer shielding 700 will tightly surround the contacting side walls of the first conductive cover 500, the second conductive cover 505, and the insulated body 300. Moreover, the first conductive cover 500 and the second conductive cover 505 are electrically contacted with upper and lower inner side walls of the outer shielding 700 by the second elastic tabs 520.

In summary, in the serial bus connector 100 of the present invention, the pair of elastic arms 620 of the plate assembly 600 engage with the pair of through holes in the two left and right side walls of the insulated body 300, and the pair of protrusions 640 of the plate assembly 600 engage in the pair of openings 320 on the first end 310 of the insulated body 300, thereby increasing the structural firmness in the assembly of the plate assembly 600 and the insulated body 300. The serial bus connector 100 of the present invention uses the elements as described above, so that the serial bus connector 100 not only has a small structure, but also has sufficient structural strength, thereby providing the connector with a longer service life.

The above descriptions are merely preferred embodiments of the present invention, and are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

While the invention has been described in terms of various specific embodiments, those skilled in the art will recognize that the invention can be practiced with modification within the spirit and scope of the claims.

What is claimed is:

1. A serial bus connector, comprising:
an upper row and a lower row of terminals;
an insulated body having a plurality of terminal passages formed thereon, each terminal passage used for accommodating a portion of a terminal, and the insulated body comprising a first end and a second end opposite the first end, a plurality of openings formed in the first end, and the second end being configured for connecting with a complementary connector;
at least one conductive cover disposed on an outer surface of a side wall of the insulated body;
a base assembly used for accommodating another portion of the terminal and used for assembling with the insulated body;
a plate assembly located between the upper and lower rows of terminals and assembling with the base assembly, and the plate assembly comprising:
at least one elastic arm extending toward the second end of the insulated body, the at least one elastic arm comprises a hook section on an end thereof and configured for electrically contacting with the complementary connector;
at least one ground section extending toward an outside of the insulated body; and
at least one protrusion, which is accommodated in a corresponding opening of the insulated body, so that the plate assembly is retained within the insulated body; and
an outer shielding sleeved onto the insulated body and the at least one conductive cover.

2. The serial bus connector as claimed in claim 1, wherein each the terminal comprises an elastic contact section, a retaining section, and a connecting section, and the insulated body comprises the plurality of terminal passages on two opposite upper and lower side walls thereof, for accommodating the elastic contact sections of the upper and lower rows of terminals.

3. The serial bus connector as claimed in claim 1, wherein the base assembly further comprises a first terminal seat engaging with the upper row of terminals and a second terminal seat engaging with the lower row of terminals, the first and second terminal seats are superposed one upon the other, and the plate assembly is located between the first terminal seat and the second terminal seat.

4. The serial bus connector as claimed in claim 3, wherein each the terminal seat comprises a plurality of first engaging units, and the insulated body comprises a plurality of upper and lower second engaging units on the first end thereof; and the insulated body is assembled with the base assembly by engaging the first engaging unit of each the terminal seat with the corresponding second engaging unit of the insulated body.

5. The serial bus connector as claimed in claim 4, wherein each engaging unit comprises a pair of structurally complementary protrusion and recess.

6. The serial bus connector as claimed in claim 3, wherein the first terminal seat comprises at least one blind hole, the second terminal seat comprises at least one post, and the plate assembly comprises at least one locating hole, and the at least one post passes through the at least one locating hole and is disposed in the at least one blind hole, so that the plate assembly, the first terminal seat, and the second terminal seat are assembled together.

7. The serial bus connector as claimed in claim 1, wherein the at least one elastic arm comprises two elastic arms, the insulated body comprises slots respectively formed on two opposite left and right side walls thereof for accommodating the two elastic arms of the plate assembly.

8. The serial bus connector as claimed in claim 2, wherein the at least one conductive cover comprises a first conductive cover and a second conductive cover, which respectively cover the plurality of the terminal passages on two opposite upper and lower side walls of the insulated body.

9. The serial bus connector as claimed in claim 8, wherein each the conductive cover comprises at least one first elastic tab configured for electrically contacting with the complementary connector.

10. The serial bus connector as claimed in claim 9, wherein the insulated body comprises at least one through hole on the two opposite upper and lower side walls thereof, so that the at least one first elastic tab of each the conductive cover passes through the at least one through hole to electrically contact with the complementary connector.

11. The serial bus connector as claimed in claim 9, wherein each the conductive cover comprises at least one second elastic tab, which outwardly extends to electrically contact with the outer shielding.

12. The serial bus connector as claimed in claim 8, wherein each the conductive cover comprises embedding tabs on two sides thereof, for fixing in the insulated body.

13. The serial bus connector as claimed in claim 1, wherein each of the terminals of the upper row has a configuration similar to a configuration of each the terminals of the lower row.

14. A universal serial bus connector, comprising:
an upper terminal set having an upper row of terminals and a lower terminal set having a lower row of terminals, each of the terminals of the upper row having a configuration similar to a configuration of each of the terminals of the lower row;
an insulated body having a plurality of upper terminal passages receiving the terminals of the upper row, a plurality of lower terminal passages receiving the terminals of the lower row, and a first end and a second end opposite the first end, a plurality of openings formed in the first end, and the second end being configured for connecting with a complementary connector;
a plate assembly located between the upper and lower rows of terminals and assembling between the upper and lower terminal sets, and the plate assembly comprising:
at least one elastic arm extending toward the second end of the insulated body, the at least one elastic arm comprises a hook section on an end thereof extending through the insulated body into an inside thereof and configured for electrically contacting with the complementary connector;
at least one ground section extending toward an outside of the insulated body; and
at least one protrusion, which is accommodated in a corresponding opening of the insulated body, so that the plate assembly is securely retained to the insulated body; and
an outer shielding sleeved onto the insulated body and the upper and lower terminal sets.
